(19) United States
(12) Patent Application Publication
(10) Pub. No.: US 2025/0350939 A1
(43) Pub. Date: Nov. 13, 2025

(54) AUTHENTICATION AND CONNECTION ESTABLISHMENT FOR REDUCED CAPABILITY DEVICES

(71) Applicant: Lenovo (Singapore) Pte Ltd, Singapore (SG)

(72) Inventors: Andreas Kunz, Ladenburg (DE); Hyung-Nam Choi, Ottobrunn (DE); Karthikeyan Ganesan, Kronberg Im Taunus (DE); Sheeba Backia Mary Baskaran, Friedrichsdorf (DE)

(73) Assignee: Lenovo (Singapore) Pte Ltd, Singapore (SG)

(21) Appl. No.: 18/661,345

(22) Filed: May 10, 2024

(51) Int. Cl. H04W 12/06; H04W 12/0431; H04W 12/72; H04W 84/12

(52) U.S. Cl. CPC H04W 12/06; H04W 12/0431; H04W 12/72; H04W 84/12

(57) ABSTRACT

Various aspects of the present disclosure relate to authentication and connection establishment for reduced capability devices. An apparatus, such as an ambient internet of things (AIoT) device, receives a broadcast message from a reader function of a network. The AIoT device performs an authentication procedure with a server function of the network using the reader function and a network function of the network. The authentication procedure utilizes an extensible authentication protocol (EAP) authentication and key agreement prime (EAP-AKA′) authentication method. Based on the authentication procedure, the AIoT device derives an access network security key and uses the access network security key to establish a secure connection with the reader function or the network function. An application function (AF) may subscribe to registration of new AIoT devices. The AF may receive one or more parameters associated with the AIoT device after the AIoT device successfully authenticates and connects to the network.

### TECHNICAL FIELD

The present disclosure relates to wireless communications, and more specifically to network access procedures.

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

Some implementations of the method and apparatuses described herein may further include a device for wireless communication to receive, from a reader function, a first message comprising a broadcast message. The device performs an authentication procedure with a server function using, at least in part, the reader function and a network function, wherein the authentication procedure utilizes an extensible authentication protocol (EAP) authentication and key agreement prime (EAP-AKA′) authentication method based at least in part on the device being associated with an ambient internet of things (AIoT) access type. The device derives, as a result of the authentication procedure, an access network security key. The device establishes, using the access network security key, a secure connection with the reader function or the network function.

In some implementations of the method and apparatuses described herein, the device comprises an AIoT device that includes a universal subscriber identity module (USIM). The reader function comprises an AIoT reader; the network function comprises an AIoT function; and the server function comprises an authentication server function (AUSF). The first message comprises at least one of an identity request message broadcast by the reader function or an indication of an address of the network function. To perform the authentication procedure, the device transmits a second message indicating at least one of a unique AIoT identifier associated with the device or an electronic product code associated with the device. The second message comprises an Internet key exchange (IKE) message or an EAP identity response message. The device receives, from the network function and based at least in part on transmitting the second message, a third message indicating a successful result of the authentication procedure, and wherein the access network security key is derived using one or more of a subscription permanent identifier (SUPI), a global phone subscription identifier (GPSI), or the unique AIoT identifier associated with the device. The device receives, from the reader function and based at least in part on transmitting the second message, a third message indicating at least one of a SUPI or a GPSI, and wherein the access network security key is derived using one or more of the SUPI, the GPSI, or the unique AIoT identifier associated with the device. The secure connection comprises an internet protocol security (IPSec) security association (IPSec SA) between the device and the network function. The network function comprises a trusted wireless local-area network (WLAN) interworking function (TWIF); and the secure connection comprises a secure Layer 2 (L2) connection between the device and the network function. The reader function comprises a TWIF; and the secure connection comprises a secure L2 connection between the device and the reader function.

Some implementations of the method and apparatuses described herein may further include a processor for wireless communication to receive, from a reader function, a first message comprising a broadcast message; perform an authentication procedure with a server function using, at least in part, the reader function and a network function, wherein the authentication procedure utilizes an EAP-AKA′ authentication method based at least in part on an association with an AIoT access type; derive, as a result of the authentication procedure, an access network security key; and establish, using the access network security key, a secure connection with the reader function or the network function.

Some implementations of the method and apparatuses described herein may further include a method performed by a device, the method including: receiving, from a reader function, a first message comprising a broadcast message; performing an authentication procedure with a server function using, at least in part, the reader function and a network function, wherein the authentication procedure utilizes an EAP-AKA′ authentication method based at least in part on the device being associated with an AIoT access type; deriving, as a result of the authentication procedure, an access network security key; and establishing, using the access network security key, a secure connection with the reader function or the network function.

In some implementations of the method and apparatuses described herein, the method further comprising the device comprises an AIoT device that includes a USIM. The reader function comprises an AIoT reader; the network function comprises an AIoT function; and the server function comprises an AUSF. The first message comprises at least one of an identity request message broadcast by the reader function or an indication of an address of the network function. The method of performing the authentication procedure further comprises transmitting a second message indicating at least one of a unique AIoT identifier associated with the device or an electronic product code associated with the device.

Some implementations of the method and apparatuses described herein may further include a device for wireless communication to transmit, to a network exposure function (NEF), a first message indicating an AIoT access network type; receive, from the NEF and based at least in part on an authentication procedure for an AIoT device associated with the AIoT access network type, a second message indicating one or more parameters associated with the AIoT device; and perform communications with the AIoT device based at least in part on the one or more parameters.

In some implementations of the method and apparatuses described herein, the first message includes a subscribe request for authenticated AIoT devices including the AIoT device. The one or more parameters comprise at least one of a GPSI associated with the AIoT device, an electronic product code associated with the AIoT device, or a location of the AIoT device.

### BRIEF DESCRIPTION OF THE DRAWINGS

FIG. 1 illustrates an example of a wireless communications system in accordance with aspects of the present disclosure.

FIG. 2 illustrates an example of an AIoT protocol stack, in accordance with aspects of the present disclosure.

FIGS. 3a and 3b illustrate an example of a signaling diagram in accordance with aspects of the present disclosure.

FIGS. 4a and 4b illustrate an example of a signaling diagram in accordance with aspects of the present disclosure.

FIGS. 5a and 5b illustrates an example of a signaling diagram in accordance with aspects of the present disclosure.

FIG. 6 illustrates an example of a AIoT device in accordance with aspects of the present disclosure.

FIG. 7 illustrates an example of a processor in accordance with aspects of the present disclosure.

FIG. 8 illustrates an example of a network equipment (NE) in accordance with aspects of the present disclosure.

FIG. 9 illustrates a flowchart of a method performed by a AIoT device in accordance with aspects of the present disclosure.

FIG. 10 illustrates a flowchart of a method performed by a NE in accordance with aspects of the present disclosure.

### DETAILED DESCRIPTION

A wireless communications system may include one or more devices and one or more nodes that operate as part of a network. For example, a network may include a core network (CN) and one or more devices (e.g., UEs, NEs, or the like) that transmit and receive signaling. To connect with the network, a device may perform an access procedure with an access management and mobility management function (AMF) of the CN. The access procedure may include or be associated with a device authentication procedure, based on which the device may establish a secure (e.g., confidential and protected) connection with the network (e.g., with one or more nodes or one or more other devices of the network). In some cases, the one or more devices may include or be an example of one or more ambient power-enabled IoT devices, referred to herein as an AIoT devices. In such cases, the network may include or be associated with a network architecture, which may, in turn, include one or more network functions that support AIoT functionalities.

AIoT devices may be battery-less (e.g., may lack a battery) or may have limited energy storage capability (e.g., may store energy using a capacitor). As such, an AIoT device may harvest ambient energy, such as radio waves, light, motion, heat, or other suitable power source(s), to power the AIoT device. AIoT devices may have a relatively small size, relatively reduced capabilities, and decreased power consumption as compared to other IoT devices, such as those defined by 3^{rd} Generation Partnership Project (3GPP) standards (e.g., narrowband IoT (NB-IoT) devices, enhanced machine type communication (eMTC) devices). Additionally, an AIoT device may be equipped with a USIM in a similar manner as a typical UE. A USIM may support security, confidentiality, and integrity protection for the AIoT device. However, due to limited capabilities, some AIoT devices may not support as many, or may not support the same, protocols that are supported by a UE. For example, an AIoT device equipped with a USIM may not support a non-access stratum (NAS) protocol that typically occurs between a UE and an AMF of a network. A NAS protocol may manage establishment, modification, and release of signaling and data bearers between a UE and the network. Additionally, the NAS protocol may involve authentication and security procedures between the UE and the network, such as authenticating the UE, establishing secure connections, and providing confidentiality and integrity of user data and signaling. Without supporting a NAS protocol, an AIoT device may be unable to directly authenticate with a network despite being equipped with a USIM. That is, an AIoT device that does not support a NAS protocol may rely on other devices, such as gateway nodes, to generate and communicate NAS messages on behalf of the AIoT device. In some scenarios, however, relying on a gateway node for access to a network may be associated with relatively high latency and reduced communication efficiency at the AIoT device.

Aspects of the disclosure are directed to access procedures performed by an AIoT device to access a network, where the AIoT device includes a USIM. More specifically, the AIoT device may perform, as part of an access procedure, an authentication procedure with a server function (e.g., an AUSF) using one or more network functions. For instance, the network may be associated with a network architecture that includes an AIoT reader and an AIoT network function, and the AIoT network function may include or otherwise be associated with an AMF of the network. During the authentication procedure, the AIoT device may exchange one or more messages with the AIoT reader, the AIoT network function, or both, and may derive an access network security key based on information included in the one or more messages. The AIoT device may use the access network security key to establish a secure connection with the AIoT reader or the AIoT network function. In some implementations, the secure connection may be an L2 connection between the AIoT device and the AIoT network function, or between the AIoT device and the AIoT reader. In other implementations, the secure connection may be an IPSec SA between the AIoT device and the AIoT network function.

The techniques described herein further support notifying an application function (AF) of the network that one or more AIoT devices have successfully authenticated and established a secure connection to the network. The AF may subscribe to registration of AIoT devices by transmitting, to an NEF of the network, a subscribe request message. The subscribe request message may include an indication of an AIoT access network type. In response, and after a successful authentication procedure is performed by the AIoT device and the secure connection is established, the AF may receive a message indicating one or more parameters of the AIoT device. The AF may store the one or more parameters for use in subsequent communications with the AIoT device.

By utilizing the described techniques, an AIoT device in a wireless communications system can authenticate with and access a network even if the AIoT device lacks support for a NAS protocol. Thus, the AIoT device may avoid latencies and inefficiencies associated with reliance on an external device (e.g., a gateway node) for network access. For example, the AIoT device may perform an authentication procedure and establish a secure connection directly with the network without waiting for communications to be transmitted and received via a gateway node. In another example, the AIoT device may be located in an area that lacks access to such gateway nodes. Accordingly, the techniques described herein support improved connectivity and security for AIoT devices without negatively impacting performance.

Reference is made herein to communicating data or information, such as authentication procedure messages and communications that are transmitted or received between devices. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system.

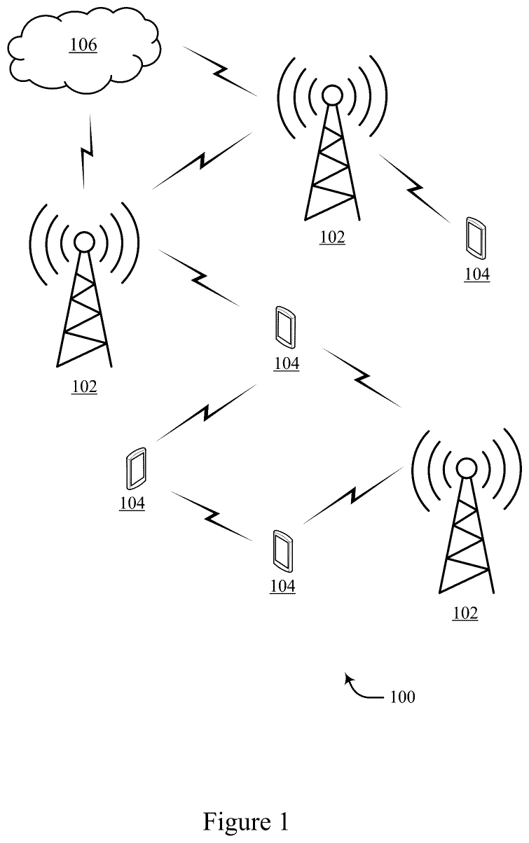

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

A network of the wireless communications system 100 may have a network architecture that includes one or more network functions operable to route data between different parts of the network and provide various network services to subscribers. Such network functions may include, but are not limited to, an AMF (e.g., for control of mobility, authentication, and session management), a session management function (SMF) (e.g., to establish, manage, and terminate data sessions between devices and external data networks), a user plane function (UPF) (e.g., to handle data forwarding and packet routing functions for user data traffic), an AUSF (e.g., to authenticate subscribers and generate security credentials for establishing secure connections), a unified data management (UDM) (e.g., to manage subscriber data and profiles within the network), and the like. Additionally, the network architecture may include an NEF (e.g., to discover and provide an interface for and external applications or services) and an AF (e.g., to provide application-level services or functionalities). The one or more network functions may be collocated (e.g., in a same device, such as the AIoT device 104 or the NE 102) or may be separate (e.g., standalone).

The network architecture may include or exclude various network functions based on supported functionalities. For instance, the network may support both 5G functionality and AIoT functionality, and may therefore include an AIoT reader and an AIoT network function. In such examples, the UE 104 may include or be an example of an AIoT device. The AIoT reader may include or be an example of a UE 104 (e.g., a UE reader), an NE 102 (e.g., a RAN reader), or the like, and may operate as an access point of the network. The AIoT network function may provide control of the AIoT device and may be a standalone network function or, alternatively, may be collocated with an AMF of the network.

In some examples, a device may be capable of accessing the network, but may not operate according to a same standard as the network, such as 3GPP standards. Such devices may include non-3GPP 5G connectivity-without-non-access stratum (N5CW) devices, authenticatable non-3GPP (AUN3) devices, and/or AIoT devices, such as the AIoT device. Thus, these devices may lack support for some network protocols, such as NAS protocols, and may be unable to directly authenticate with the network. However, access to the network may still be obtained, for example, using a non-3GPP access procedure (e.g., a trusted access procedure or an untrusted access procedure) that includes interworking between the device and the network. A gateway node including an AMF may generate NAS messages on behalf of the device and may forward the NAS messages to an NEF and an AF, which may enable the device to indirectly authenticate and establish a connection with the AF.

AIoT devices may operate in scenarios in which a long lifespan (e.g., greater than 10 years) and reduced maintenance of the AIoT device may be beneficial. For example, an AIoT device may be installed in a fixed location that is relatively inaccessible and is intended to support a long-lasting operation, such as an AIoT sensor installed under a bridge to measure water levels. As another example, an AIoT device may be used in an industrial environment, such as a warehouse. Here, the AIoT device may prioritize ultra-reliable communication and low latency to convey information between machines without interrupting production processes. Additionally, or alternatively, the AIoT device may operate without direct user interaction. Thus, in such examples, relying on interworking to access the network and to establish a secure connection may be unreliable or inefficient. Moreover, due to reduced capabilities of the AIoT device, existing subscription, registration, and/or connection management models may be incompatible with the AIoT device.

According to implementations, one or more of the NEs 102 and the AIoT device are operable to implement various aspects of the techniques described with reference to the present disclosure. For example, a wireless device, such as an AIoT device, may be equipped with a USIM to support security, confidentiality, and integrity protection. The AIoT device may perform an access procedure to directly access a network of the wireless communications system 100, e.g., without utilizing a gateway node to generate NAS messages on behalf of the AIoT device. The access procedure may include several steps to authenticate and register the AIoT device and establish a secure connection between the AIoT device and the network. The AIoT device may select an AIoT network function (e.g., of the network, which may be a public land mobile network (PLMN), such as a 5G PLMN) with which to initiate an authentication procedure. In some examples, the selected AIoT network function may include or be an example of an AIoT reader to which the AIoT device 104 is connected, or may include or be an example of an AIoT function (e.g., an AIoT reader) having a preconfigured address in the AIoT device.

The authentication procedure may include or be an example of an EAP-AKA′ authentication method, which does not utilize the NAS protocol as a transport. The AIoT device may exchange one or more messages with the AIoT network function during the authentication procedure. The AIoT network function may communicate with the AUSF to authenticate AIoT devices, such as the AIoT device. The AUSF, in turn, may transmit an indication of an AIoT device type (e.g., may indicate that the AIoT device is an AIoT device) to the UDM, and the UDM may select the EAP-AKA′ authentication method for the authentication procedure. Based on the authentication procedure, the AIoT device may derive an access network security key. Using the access network security key, the AIoT device may establish a secure connection with the AIoT network function and, in some cases, one or more additional AIoT network functions.

Additionally, some implementations support procedures for an AF of the network to subscribe to registration of AIoT devices new to the network, such as the AIoT device. In some examples, the AF may be an example of an NE 102. The AF may transmit a subscribe request message to an NEF, where the subscribe request message indicates an AIoT access network type. After authentication and connection procedures by the AIoT device are successful, the AF may receive signaling indicating information (e.g., one or more parameters) about the AIoT device, for instance, from the NEF. The AF may store the information for use in subsequent communications with the AIoT device, e.g., to transmit signaling (e.g., including commands or instructions) to the AIoT device.

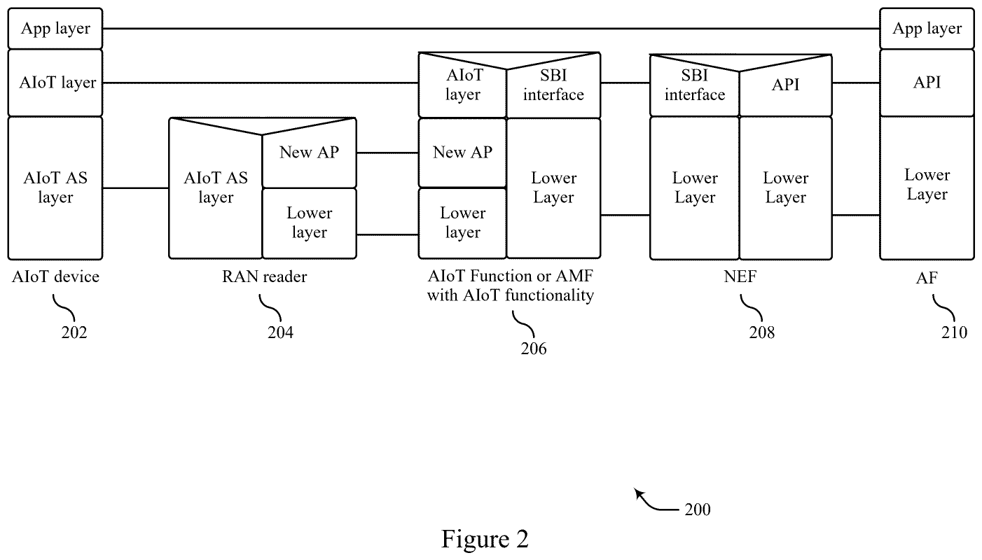

FIG. 2 illustrates an example of an AIoT protocol stack 200 in accordance with aspects of the present disclosure. In this example, the AIoT protocol stack 200 includes an AIoT device 202, a RAN reader 204, an AIoT function or an AMF with AIoT functionality 206, an NEF 208, and an AF 210. In some examples, the AIoT protocol stack 200 implements or is implemented by aspects of the wireless communications system 100. For example, the AIoT device 202 may be an example of an AIoT device as described with reference to FIG. 1, and the RAN reader 204 may include or be an example of an NE as described with reference to FIG. 1. Additionally, the AIoT function or AMF with AIoT functionality 206, the NEF 208, and the AF 210 may be examples of network functions as described herein. The AIoT device 202 and the network functions may be associated with a network, such as a 5G PLMN. The network functions support at least a subset of AIoT functionalities.

The AIoT device 202 may be equipped with a USIM to support security, confidentiality, and integrity protection in communications with other devices and network functions. The AIoT device 202 may not be capable of supporting some network protocols, such as a NAS protocol used to access a network. Additionally, existing network architecture and protocol stacks may not be compatible with the AIoT device 202, e.g., due to the reduced capabilities and limited power of the AIoT device 202.

Accordingly, the AIoT protocol stack 200 illustrates an example of control plane delivery of commands and instructions towards the AIoT device 202 from a corresponding AF 210 (e.g., an AF in charge of the AIoT device 202). The AIoT protocol stack 200 may be relatively simplified, e.g., as compared to a protocol stack associated with a UE or an NE. However, existing solutions may not consider how the AIoT device 202, equipped with a USIM, may directly authenticate with the network via the AIoT function or AMF with AIoT functionality 206. That is, such solutions may not enable security on various layers from the AIoT device 202 towards the network.

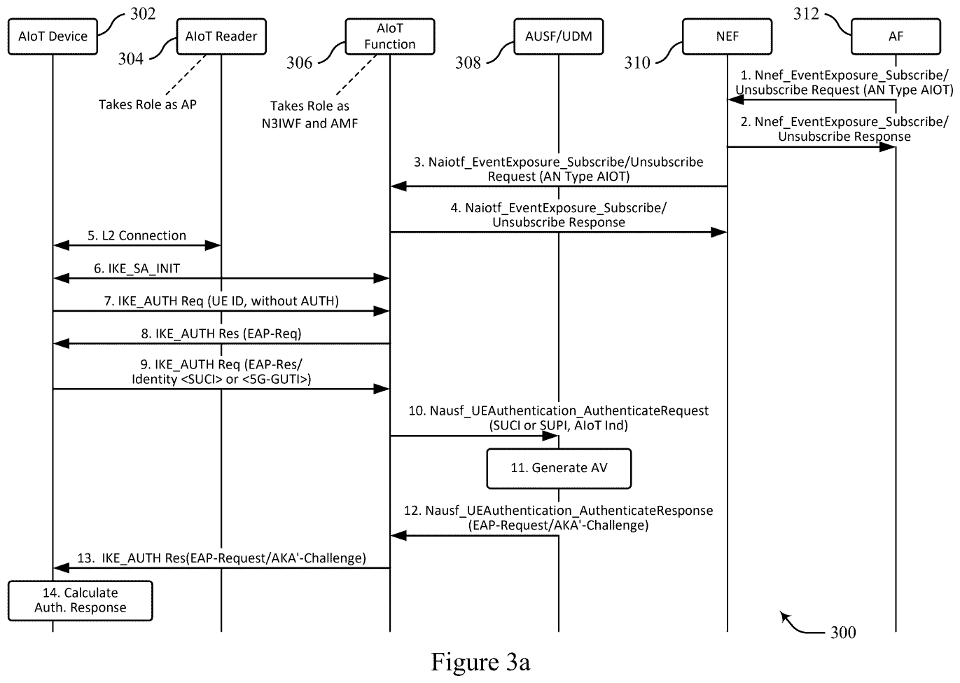

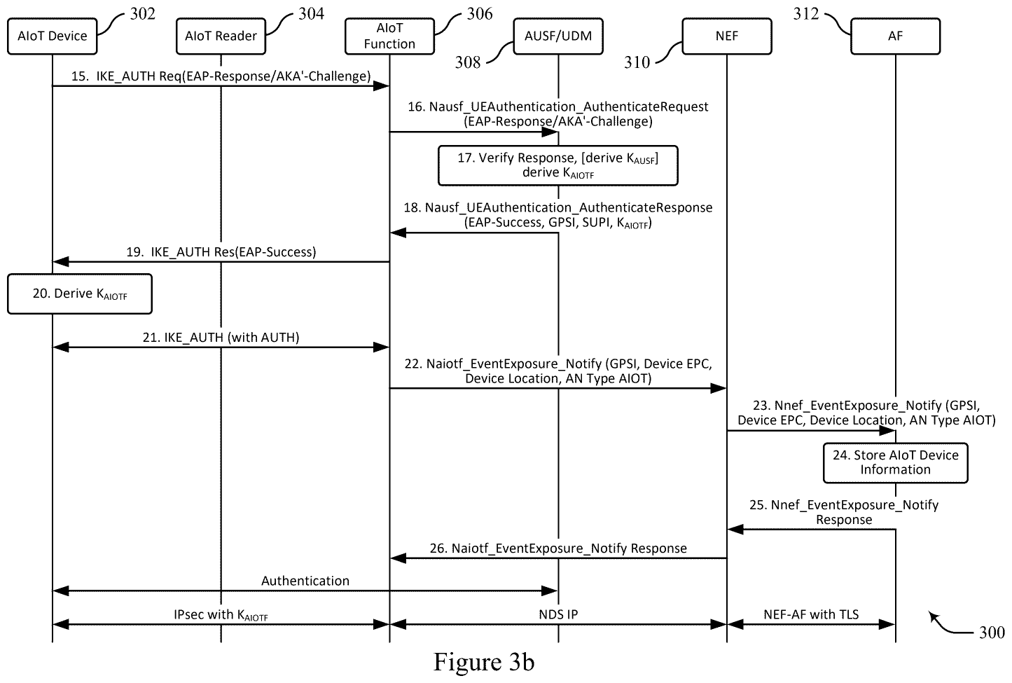

FIGS. 3a and 3b illustrate an example of a signaling diagram 300 in accordance with aspects of the present disclosure. Notably, the FIGS. 3a and 3b each illustrate respective, subsequent portions of a same signaling diagram, such that a device or devices implementing the signaling diagram 300 may perform the techniques described in FIG. 3a followed by the techniques described in FIG. 3b. In some examples, the signaling diagram 300 implements or is implemented by aspects of the wireless communications system 100. For example, the signaling diagram 300 includes an AIoT device 302 and one or more network functions, which may be examples of an AIoT device and network functions as described with reference to FIG. 1. The network functions include an AIoT reader 204, an AIoT function 306, an AUSF/UDM 308, an NEF 310, and an AF 312. The AIoT device 302 and the network functions may be associated with a network, such as a 5G PLMN. The network functions support at least a subset of AIoT functionalities.

The signaling diagram 300 illustrates an access procedure in which the AIoT device 302 may directly authenticate with and establish a secure connection to the network, e.g., without a gateway node to generate NAS messages on behalf of the AIoT device 302. More specifically, in the signaling diagram 300, the AIoT device 302 utilizes an EAP-AKA′ authentication method to establish an IPsec SA between the AIoT device 302 and the AIoT function 306. The AF may subscribe to registration of new AIoT devices (e.g., AIoT devices that have not previously connected to the network) and, after the authentication procedure has been performed and the secure connection established, may receive signaling indicating one or more parameters of the AIoT device 302. The AF 312 may be authenticated by the NEF 310, e.g., based on transport layer security (TLS) or a local configuration at the NEF 310. If a token-based authorization mechanism is used, a token is generated for the AF 312 after authentication and authorization.

In the signaling diagram 300, the AIoT reader 304 may include or operate as an access point. Additionally, the AIoT function 306 may include or operate as an AMF and/or a non-3GPP interworking function (N3IWF) when communicating with the AUSF for authentication. It is to be understood that, while the AUSF/UDM 308 is shown as a single device in the signaling diagram 300, the steps performed by the AUSF/UDM 308 may be performed separately by the AUSF and/or the UDM.

At step 1, the AF 312 may subscribe or unsubscribe for authenticated AIoT devices by transmitting a subscribe request message or an unsubscribe request message, respectively (e.g., Nnef_EventExposure_Subscribe/Unsubscribe Request), to the NEF 310. The request message may include an indication of the access network type. In the example of the signaling diagram 300, the access network type may be an AIoT access network type.

At step 2, in response to the request message, the NEF 310 may transmit, to the AF 312, a response message (e.g., Nnef_EventExposure_Subscribe/Unsubscribe Response) to confirm reception of the request message.

At step 3, the NEF 310 checks whether the AF 312 is authorized for the requested subscription (e.g., authenticated AIoT devices) based on the AF token. If the AF 312 is authorized, the NEF 310 may query a network repository function (NRF) of the network to determine an associated AIoT function, such as the AIoT function 306. The NEF 310 forwards the request message received from the AF 312 (e.g., at step 1) to the AIoT function 306. The forwarded request message (e.g., Nnef_EventExposure_Subscribe/Unsubscribe Request) includes the indication of the AIoT access network type.

At step 4, the AIoT function 306 confirms receipt of the forwarded request message by transmitting a response message (e.g., Naiotf_EventExposure_Subscribe/Unsubscribe Response) to the NEF 310.

At step 5, the AIoT device 302 connects (e.g., attaches) to the AIoT reader 304 as an access network. In some examples, the AIoT device 302 may be triggered by the AIoT reader 304 to initiate the connection, e.g., based on receiving a broadcast message from the AIoT reader 304. The connection may be an L2 connection.

When the AIoT device 302 determines to attach to the AIoT reader 304, the AIoT device 302 selects an AIoT function of the network, such as the AIoT function 306. The selected AIoT function (e.g., the AIoT function 306) may be associated with a network address. In some examples, the AIoT device 302 may receive the network address of the AIoT function 306 in a broadcast message transmitted by an AIoT reader to which the AIoT device 302 is connected (e.g., the AIoT reader 304). Additionally, or alternatively, the network address of the AIoT function 306 may be preconfigured in the AIoT device 302.

At step 6, the AIoT device 302 may proceed with establishment of the IPsec SA with the AIoT function 306 by initiating an IKE initial exchange (e.g., IKE_SA_INIT).

At step 7, the AIoT device 302 may initiate an authorization exchange (e.g., IKE_AUTH) by transmitting, to the AIoT function 306, an IKE_AUTH request message. In some examples, the IKE_AUTH message may exclude an AUTH payload. Exclusion of the AUTH payload from the IKE_AUTH message may serve as an indication that the IKE_AUTH exchange is to utilize EAP signaling (e.g., EAP-5G signaling).

At step 8, the AIoT function 306 may respond to the IKE_AUTH request message by transmitting, to the AIoT device 302, an IKE_AUTH response message. The IKE_AUTH response message may include an indication of an AIoT function identity associated with the AIoT function 306, an AUTH payload to protect messages previously transmitted to the AIoT device 302 (e.g., as part of the IKE_SA_INIT exchange), and an EAP request indication (e.g., an EAP-Request/5G-Start packet).

At step 9, the AIoT device 302 may validate a certificate of the AIoT function 306 (e.g., based on the IKE_SA_INIT and the IKE_AUTH exchanges) and may confirm that a N3IWF identity associated with the certificate corresponds to (e.g., matches) the AIoT function 306. The AIoT device 302 may send an additional IKE_AUTH request message to the AIoT function 306. Here, the additional IKE_AUTH request message may include an EAP-Response/5G-NAS packet that contains a unique AIoT identifier associated with the AIoT device 302. For example, the unique AIoT identifier may include or be an example of a subscription concealed identifier (SUCI), a globally unique temporary identifier (e.g., 5G-GUTI), or the like. Additionally, in some cases, the additional IKE_AUTH request message may include an electronic product code associated with the AIoT device 302.

At step 10, the AIoT function 306 may select an AUSF of the network, such as the AUSF/UDM 308. The AIoT function 306 may transmit, to the AUSF/UDM 308, an authentication request message (e.g., Nausf_UEAuthentication_Authenticate Request). The authentication request message may include an indication of the SUCI (e.g., if the AIoT function 306 received the SUCI of the AIoT device 302 at step 9) or a SUPI (e.g., if the AIoT function 306 received the 5G-GUTI of the AIoT device 302 at step 9). Additionally, the authentication request message may include an indication that the authentication request is associated with (e.g., is for authentication of) an AIoT device (e.g., the AIoT device 302), which may be referred to as an AIoT device indication.

At step 11, the AUSF of the AUSF/UDM 308 may transmit, to the UDM of the AUSF/UDM 308, a request message (e.g., Nudm_UEAuthentication_Get) that includes the SUCI or SUPI and the AIoT device indication. Upon reception of the request message, the UDM may initiate a subscription identification data function (SIDF) if the request message includes the SUCI. The UDM may utilize the SIDF to de-conceal the SUCI to obtain the SUPI prior to processing the request message. The UDM may select an authentication method based on a realm associated with the SUPI, the AIoT device indicator, a combination of the realm and the AIoT device indicator, or a UDM local policy. The UDM may generate an authentication vector AV according to the authentication method. The authentication vector AV may include a set of parameters, which may include, but is not limited to, a network challenge (e.g., a random number (RAND)), an expected user response (e.g., a signed response (XRES)), a cipher key (CK), an integrity key (IK), and an authentication token (AUTN). The UDM may transform the authentication vector AV into an authentication vector AV′ and may transmit the AV′ to the AUSF. In some cases, the UDM may also transmit an indication of a master session key (MSK) to the AUSF to indicate that the AIoT device 302 does not support a 5G key hierarchy.

At step 12, the AUSF may transmit, to the AIoT function 306, an EAP-Request/AKA′-Challenge message, for instance, as part of a response message (e.g., a Nausf_UEAuthentication_Authenticate Response message).

At step 13, the AIoT function 306 may transparently forward the EAP-Request/AKA′-Challenge message to the AIoT device 302, e.g., as part of an IKE_AUTH response message.

At step 14, the AIoT device 302 may compute an authentication response message, e.g., based on receiving the EAP-Request/AKA′-Challenge message from the AIoT function 306. The computed authentication response message may include a user response (e.g., RES).

Referring now to FIG. 3b, at step 15, the AIoT device 302 may transmit the computed authentication response message (e.g., an EAP-Response/AKA′-Challenge message) to the AIoT function 306, for instance, as part of an Auth-Resp message.

At step 16, the AIoT function 306 may transparently forward the EAP-Response/AKA′-Challenge message to the AUSF, for example, as part of a Nausf_UEAuthentication_Authenticate request message.

At step 17, the AUSF may verify the authentication response message by comparing the XRES of the AV and the RES indicated in the authentication response message. If the verification is successful, for example, based on the MSK indicator received from the UDM at step 11, the AUSF may generate the MSK or may generate an authentication key K_{AUSF}. The AUSF may then calculate an access network security key for the AIoT device 302 (e.g., K_{AIOTF}) from the authentication key K_{AUSF}. In some examples, the AUSF may generate K_{AIOTF} in a manner similar to that used to generate other keys (e.g., K_{TNGF}/K_{TWIF}/K_{N3IWF}), but with an Uplink NAS Count set to “0”, or using the MSK. In some examples, the K_{AIOTF} may be the same as (e.g., equal to) the MSK.

At step 18, the AUSF may transmit, to the AIoT function 306, a Nausf_UEAuthentication_Authenticate Response message including an indication that the EAP was successful (e.g., EAP-Success), the K_{AIOTF}, the SUPI, and, if available, a GPSI.

At step 19, based on receiving the K_{AIOTF}, the SUPI, and, if available, the GPSI, the AIoT function 306 may transmit a success message (e.g., an EAP-Success/EAP-5G message) to the AIoT device 302.

At step 20, the AIoT device 302 may derive an access network security key K_{AIOTF}. In some examples, the AIoT device 302 may derive the K_{AIOTF} in a similar manner as the derivation performed by the AUSF, e.g., based on the SUPI, the GPSI, and/or the unique identifier associated with the AIoT device 302.

At step 21, the AIoT device 302 may establish the IPsec SA between the AIoT device 302 and the AIoT function 306 using the access network security key K_{AIOTF}.

At step 22, the AIoT function 306 may trigger a notification toward the AF 312. Based on the trigger, the AIoT function 306 may transmit, to the NEF 310, a Naiotf_Event Exposure_Notify message, which may include an indication of an event identifier (ID), an indication of an event filter, and any relevant event reporting information. Additionally, in some examples, the Naiotf_Event Exposure_Notify message may include the GPSI, the EPC, an indication of a location of the AIoT device 302, an indication of the AIoT access network type, or the like.

At step 23, the NEF 310 may forward the Naiotf_Event Exposure_Notify message to the AF 312. The Naiotf_Event Exposure_Notify message may contain the GPSI, the EPC, the indication of the location of the AIoT device 302, the indication of the AIoT access network type, or the like. In some examples, the NEF 310 may transmit a Naiotf_Event Exposure_Notify message that includes information associated with a single AIoT function 306, while in other examples, the NEF 310 may aggregate reporting information (e.g., event ID, event filter, event reporting information) for multiple AIoT functions and may include the aggregated reporting information in the Naiotf_Event Exposure_Notify message. In the latter case, the Naiotf_Event Exposure_Notify message may indicate a respective GPSI, electronic product code, location indication, and/or AIoT access network type indication for each of the AIoT devices authenticated by a respective AIoT function.

At step 24, the AF 312 may store information associated with the AIoT device 302, e.g., as indicated in the Naiotf_Event Exposure_Notify message received from the NEF 310.

At step 25, the AF 312 may transmit an acknowledgement of reception of the Naiotf_Event Exposure_Notify message to the NEF 310.

At step 26, the NEF 310 may transmit, to the AIoT function 306, an acknowledgement of reception of the Naiotf_Event Exposure_Notify message.

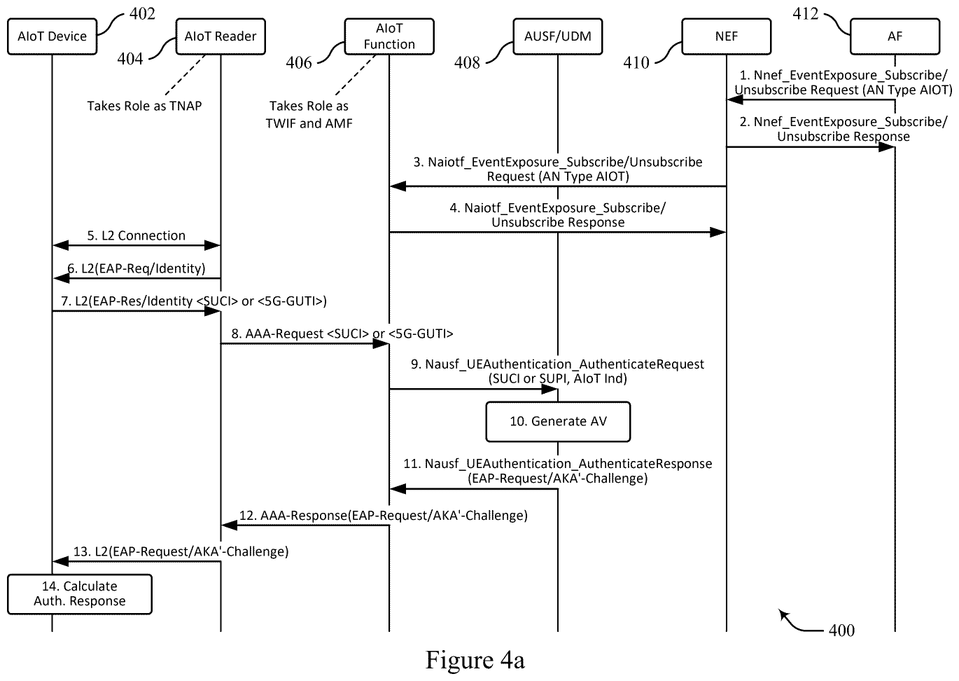

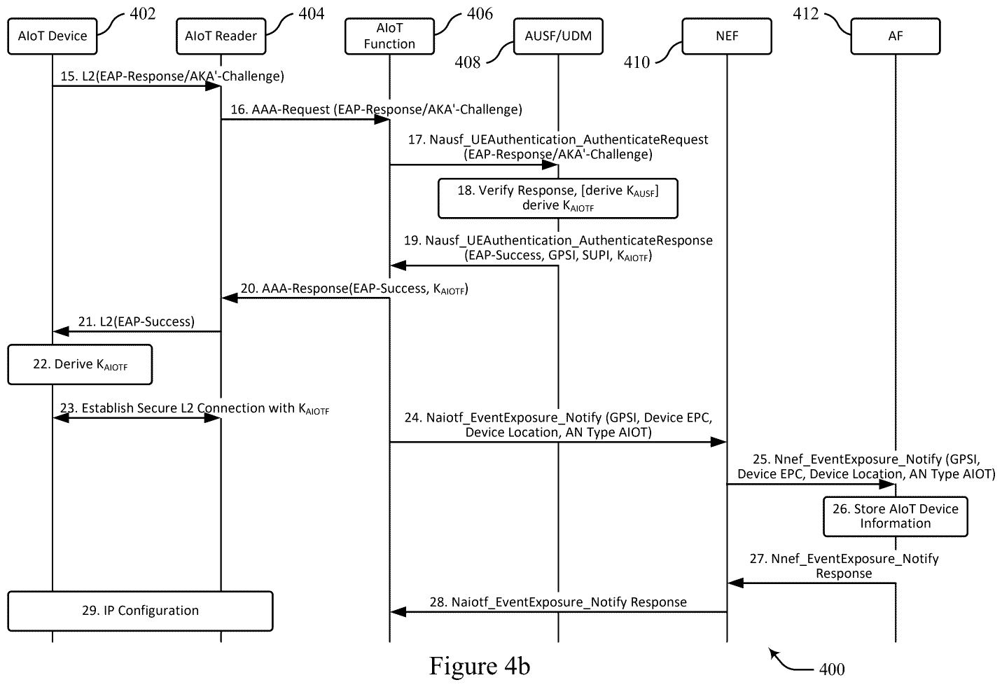

FIGS. 4a and 4b illustrate examples of a signaling diagram 400 in accordance with aspects of the present disclosure. Notably, the FIGS. 4a and 4b each illustrate respective, subsequent portions of a same signaling diagram, such that a device or devices implementing the signaling diagram 400 may perform the techniques described in FIG. 4a followed by the techniques described in FIG. 4b. In some examples, the signaling diagram 400 implements or is implemented by aspects of the wireless communications system 100. For example, the signaling diagram 400 includes an AIoT device 402 and one or more network functions, which may be examples of an AIoT device and network functions as described with reference to FIG. 1. The network functions include an AIoT reader 404, an AIoT function 406, an AUSF/UDM 408, an NEF 410, and an AF 412. The AIoT device 402 and the network functions may be associated with a network, such as a 5G PLMN. The network functions support at least a subset of AIoT functionalities.

The signaling diagram 400 illustrates an access procedure in which the AIoT device 402 may directly authenticate with and establish a secure connection to the network, e.g., without a gateway node to generate NAS messages on behalf of the AIoT device 402. More specifically, in the signaling diagram 400, the AIoT device 402 utilizes an EAP-AKA′ authentication method to establish a secure L2 connection between the AIoT device 402 and the AIoT reader 404. The AF 412 may subscribe to registration of new AIoT devices (e.g., AIoT devices that have not previously connected to the network) and, after the authentication procedure has been performed and the secure connection established, may receive signaling indicating one or more parameters of the AIoT device 402. The AF 412 may be authenticated by the NEF 410, e.g., based on TLS or a local configuration at the NEF 410. If a token-based authorization mechanism is used, a token is generated for the AF 412 after authentication and authorization.

In the signaling diagram 400, the AIoT reader 404 may include or operate as a trusted non-3GPP access point (TNAP). Additionally, the AIoT function 406 may include or operate as an AMF, a trusted non-3GPP gateway function (TNGF), and/or a TWIF when communicating with the AUSF for authentication. It is to be understood that, while the AUSF/UDM 408 is shown as a single device in the signaling diagram 400, the steps performed by the AUSF/UDM 408 may be performed separately by the AUSF and/or the UDM.

At step 1, the AF 412 may subscribe or unsubscribe for authenticated AIoT devices by transmitting a subscribe request message or an unsubscribe request message, respectively (e.g., Nnef_EventExposure_Subscribe/Unsubscribe Request), to the NEF 410. The request message may include an indication of the access network type. In the example of the signaling diagram 400, the access network type may be an AIoT access network type.

At step 2, in response to the request message, the NEF 410 may transmit, to the AF 412, a response message (e.g., Nnef_EventExposure_Subscribe/Unsubscribe Response) to confirm reception of the request message.

At step 3, the NEF 410 checks whether the AF 412 is authorized for the requested subscription (e.g., authenticated AIoT devices) based on the AF token. If the AF 412 is authorized, the NEF 410 may query an NRF of the network to determine an associated AIoT function, such as the AIoT function 406. The NEF 410 forwards the request message received from the AF 412 (e.g., at step 1) to the AIoT function 406. The forwarded request message (e.g., Nnef_EventExposure_Subscribe/Unsubscribe Request) includes the indication of the AIoT access network type.

At step 4, the AIoT function 406 confirms receipt of the forwarded request message by transmitting a response message (e.g., Naiotf_EventExposure_Subscribe/Unsubscribe Response) to the NEF 410.

At step 5, the AIoT device 402 connects (e.g., attaches) to the AIoT reader 404 as an access network. In some examples, the AIoT device 402 may be triggered by the AIoT reader to initiate the connection, e.g., based on receiving a broadcast message from the AIoT reader. The connection may be an L2 connection.

At step 6, the AIoT reader 404 may transmit, to the AIoT device 402, an L2 message including an EAP-Identify Request. In some examples, step 6 may be included as part of step 5.

At step 7, the AIoT device 402 may transmit a response message to the AIoT reader 404. The response message may be, for example, an EAP-Identify Response message and may include an indication of a unique identifier of the AIoT device 402 (e.g., a network access identity (NAI), such as a SUCI or 5G-GUTI) and/or an equipment product code of the AIoT device 402.

At step 8, the AIoT reader 404 may select an AIoT function of the network, such as the AIoT function 406. The AIoT reader 404 may transmit an authentication, authorizing, and accounting (AAA) request to the AIoT function 406 (e.g., based on the selecting). In some examples, the AIoT reader 404 may include, in the AAA request, information received from the AIoT device 402, such as the EPC or a location of the AIoT device 402.

At step 9, the AIoT function 406 may select an AUSF of the network, such as the AUSF/UDM 408. The AIoT function 406 may transmit, to the AUSF/UDM 408, an authentication request message (e.g., Nausf_UEAuthentication_Authenticate Request). The authentication request message may include an indication of the SUCI (e.g., if the AIoT function 406 received the SUCI of the AIoT device 402 at step 9) or a SUPI (e.g., if the AIoT function 406 received the 5G-GUTI of the AIoT device 402 at step 9). Additionally, the authentication request message may include an indication that the authentication request is associated with (e.g., is for authentication of) an AIoT device (e.g., the AIoT device 402), which may be referred to as an AIoT device indication.

At step 10, the AUSF may transmit, to the UDM, a request message (e.g., Nudm_UEAuthentication_Get) that includes the SUCI or SUPI and the AIoT device indication. Upon reception of the request message, the UDM may initiate a SIDF if the request message includes the SUCI. The UDM may utilize the SIDF to de-conceal the SUCI to obtain the SUPI prior to processing the request message.

The UDM may select an authentication method based on a realm associated with the SUPI, the AIoT device indicator, a combination of the realm and the AIoT device indicator, or a UDM local policy. The UDM may generate an authentication vector AV according to the authentication method. The authentication vector AV may include a set of parameters, which may include, but is not limited to, a network challenge (e.g., a RAND), an expected user response (e.g., a signed response (XRES)), a CK, an IK, and an AUTN. The UDM may transform the authentication vector AV into an authentication vector AV′ and may transmit the AV′ to the AUSF. In some cases, the UDM may also transmit an indication of an MSK to the AUSF to indicate that the AIoT device 402 does not support a 5G key hierarchy.

At step 11, the AUSF may transmit, to the AIoT function 406, an EAP-Request/AKA′-Challenge message, for instance, as part of a response message (e.g., a Nausf_UEAuthentication_Authenticate Response message).

At step 12, the AIoT function 406 may transparently forward the EAP-Request/AKA′-Challenge message to the AIoT reader 404, e.g., as part of an AAA response message.

At step 13, the AIoT function 406 may forward the EAP-Request/AKA′-Challenge message to the AIoT device 402, e.g., as part of an L2 message.

At step 14, the AIoT device 402 may compute an authentication response message, e.g., based on receiving the EAP-Request/AKA′-Challenge message from the AIoT function 406. The computed authentication response message may include a user response (e.g., RES).

Referring now to FIG. 4b, at step 15, the AIoT device 402 may transmit the computed authentication response message (e.g., an EAP-Response/AKA′-Challenge message) to the AIoT reader 404, for instance, as part of an L2 Auth-Resp message.

At step 16, the AIoT reader 404 may transmit the authentication response message (e.g., the EAP-Response/AKA′-Challenge message received from the AIoT device 402) to the AIoT function 406, for example, as part of an AAA request message.

At step 17, the AIoT function 406 may transparently forward the EAP-Response/AKA′-Challenge message to the AUSF, for example, as part of a Nausf_UEAuthentication_Authenticate request message.

At step 18, the AUSF may verify the authentication response message by comparing the XRES of the AV and the RES indicated in the authentication response message. If the verification is successful, for example, based on the MSK indicator received from the UDM at step 10, the AUSF may generate the MSK or may generate an authentication key K_{AUSF}. The AUSF may then calculate an access network security key for the AIoT device 402 (e.g., K_{AIOTF}) from the authentication key K_{AUSF}. In some examples, the AUSF may generate K_{AIOTF} in a manner similar to that used to generate other keys (e.g., K_{TNGF}/K_{TWIF}/K_{N3IWF}), but with an Uplink NAS Count set to “0”, or from the MSK. In some examples, the K_{AIOTF} may be the same as (e.g., equal to) the MSK.

At step 19, the AUSF may transmit, to the AIoT function 406, a Nausf_UEAuthentication_Authenticate Response message including an indication that the EAP was successful (e.g., EAP-Success), the K_{AIOTF}, the SUPI, and, if available, the GPSI.

At step 20, based on receiving the K_{AIOTF}, the SUPI, and, if available, the GPSI, the AIoT function 406 may transmit a success message (e.g., an EAP-Success/EAP-5G message) to the AIoT reader 404.

At step 21, the AIoT reader 404 may store the K_{AIOTF} and may forward the success message (e.g., the EAP-Success/EAP-5G message) to the AIoT device 402, e.g., as part of an L2 message.

At step 22, the AIoT device 402 may derive an access network security key K_{AIOTF}. In some examples, the AIoT device 402 may derive the K_{AIOTF} in a similar manner as the derivation performed by the AUSF, e.g., based on the SUPI, the GPSI, and/or the unique identifier associated with the AIoT device 402.

At step 23, the AIoT device 402 and the AIoT reader 404 may set up a secure L2 connection using the access network security key K_{AIOTF}, which may enable protection for any subsequent communications between the AIoT device 402 and the AIoT reader 404.

At step 24, the AIoT function 406 may trigger a notification toward the AF 412. Based on the trigger, the AIoT function 406 may transmit, to the NEF 410, a Naiotf_Event Exposure_Notify message, which may include an indication of an event ID, an indication of an event filter, and any relevant event reporting information. Additionally, in some examples, the Naiotf_Event Exposure_Notify message may include the GPSI, the EPC, an indication of a location of the AIoT device 402, an indication of the AIoT access network type, or the like.

At step 25, the NEF 410 may forward the Naiotf_Event Exposure_Notify message to the AF 412. The Naiotf_Event Exposure_Notify message may contain the GPSI, the EPC, the indication of the location of the AIoT device 402, the indication of the AIoT access network type, or the like. of the device(s) authenticated with the AIoT function(s). In some examples, the NEF 410 may transmit a Naiotf_Event Exposure_Notify message that includes information associated with a single AIoT function 406, while in other examples, the NEF 410 may aggregate reporting information (e.g., event ID, event filter, event reporting information) for multiple AIoT functions and may include the aggregated reporting information in the Naiotf_Event Exposure_Notify message. In the latter case, the Naiotf_Event Exposure_Notify message may indicate a respective GPSI, EPC, location indication, and/or AIoT access network type indication for each of the AIoT devices authenticated by a respective AIoT function.

At step 26, the AF 412 may store information associated with the AIoT device 402, e.g., as indicated in the Naiotf_Event Exposure_Notify message received from the NEF 410.

At step 27, the AF 412 may transmit an acknowledgement of reception of the Naiotf_Event Exposure_Notify message to the NEF 410.

At step 28, the NEF 410 may transmit, to the AIoT function 406, an acknowledgement of reception of the Naiotf_Event Exposure_Notify message.

At step 29, the AIoT device 402 may retrieve (e.g., using a DCHP) an internet protocol (IP) configuration from the AIoT function 406.

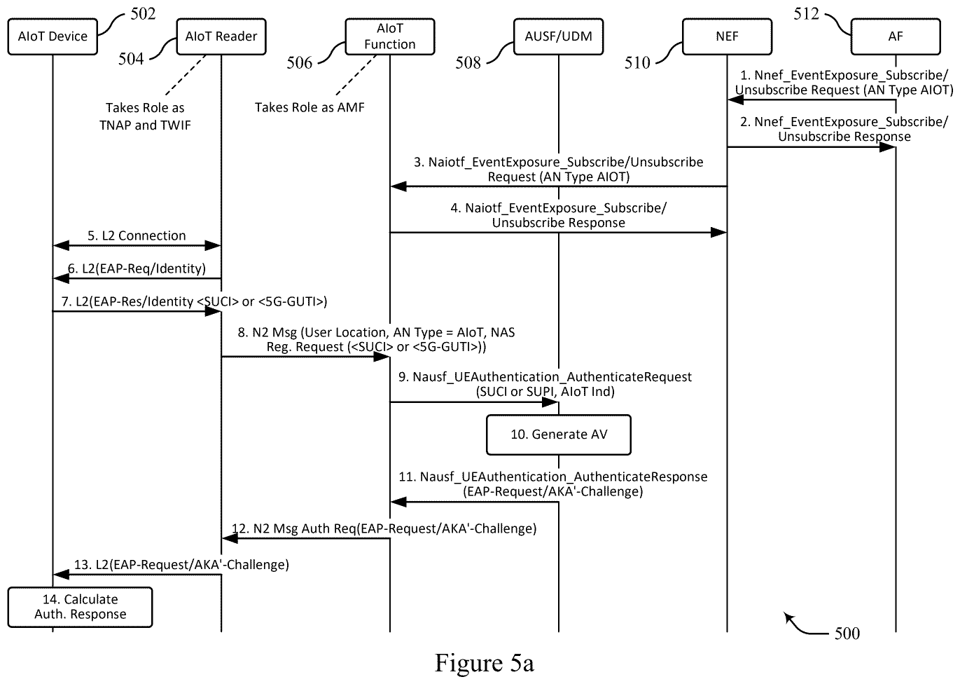

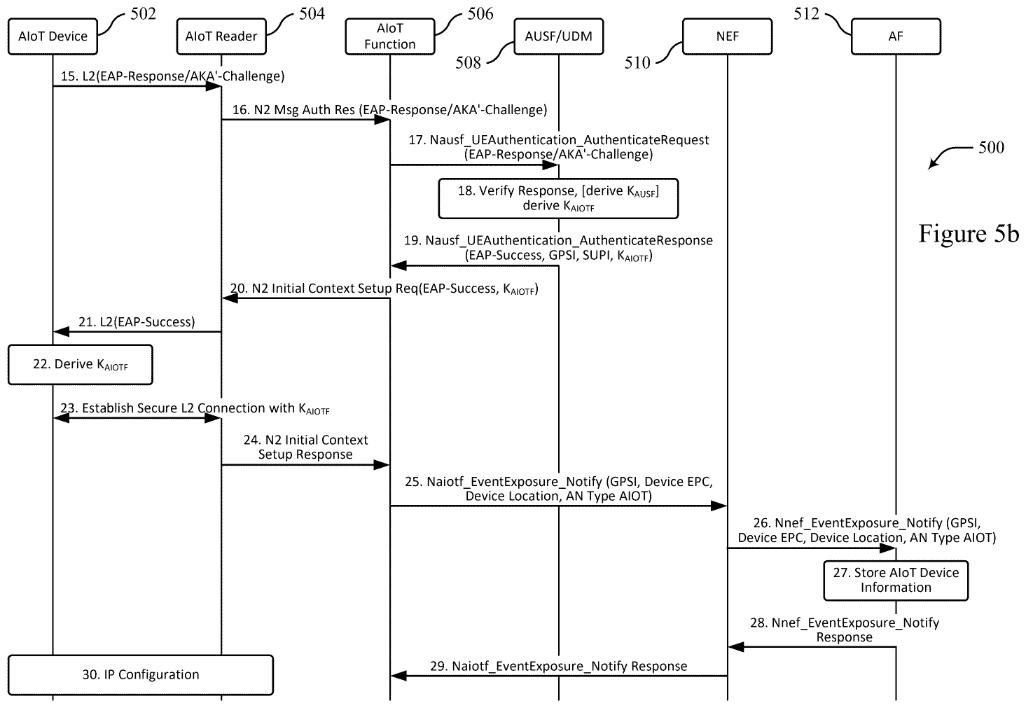

FIGS. 5a and 5b illustrate examples of a signaling diagram 400 in accordance with aspects of the present disclosure. Notably, the FIGS. 5a and 5b each illustrate respective, subsequent portions of a same signaling diagram, such that a device or devices implementing the signaling diagram 500 may perform the techniques described in FIG. 5a followed by the techniques described in FIG. 5b. In some examples, the signaling diagram 500 implements or is implemented by aspects of the wireless communications system 100. For example, the signaling diagram 500 includes an AIoT device 502 and one or more network functions, which may be examples of an AIoT device and network functions as described with reference to FIG. 1. The network functions include an AIoT reader 504, an AIoT function 506, an AUSF/UDM 508, an NEF 510, and an AF 512. The AIoT device 502 and the network functions may be associated with a network, such as a 5G PLMN. The network functions support at least a subset of AIoT functionalities.

The signaling diagram 500 illustrates an access procedure in which the AIoT device 502 may directly authenticate with and establish a secure connection to the network, e.g., without a gateway node to generate NAS messages on behalf of the AIoT device 502. More specifically, in the signaling diagram 500, the AIoT device 502 utilizes an EAP-AKA′ authentication method to establish a secure L2 connection between the AIoT device 502 and the AIoT reader 504. The AF 512 may subscribe to registration of new AIoT devices (e.g., AIoT devices that have not previously connected to the network) and, after the authentication procedure has been performed and the secure connection established, may receive signaling indicating one or more parameters of the AIoT device 502. The AF 512 may be authenticated by the NEF 510, e.g., based on TLS or a local configuration at the NEF 510. If a token-based authorization mechanism is used, a token is generated for the AF 512 after authentication and authorization.

In the signaling diagram 500, the AIoT reader 504 may include or operate as a TNAP, a TNGF, and a TWIF. Additionally, the AIoT function 506 may include or operate as an AMF when communicating with the AUSF for authentication. It is to be understood that, while the AUSF/UDM 508 is shown as a single device in the signaling diagram 500, the steps performed by the AUSF/UDM 508 may be performed separately by the AUSF and/or the UDM.

At step 1, the AF 512 may subscribe or unsubscribe for authenticated AIoT devices by transmitting a subscribe request message or an unsubscribe request message, respectively (e.g., Nnef_EventExposure_Subscribe/Unsubscribe Request), to the NEF 510. The request message may include an indication of the access network type. In the example of the signaling diagram 500, the access network type may be an AIoT access network type.

At step 2, in response to the request message, the NEF 510 may transmit, to the AF 512, a response message (e.g., Nnef_EventExposure_Subscribe/Unsubscribe Response) to confirm reception of the request message.

At step 3, the NEF 510 checks whether the AF 512 is authorized for the requested subscription (e.g., authenticated AIoT devices) based on the AF token. If the AF 512 is authorized, the NEF 510 may query a NRF of the network to determine an associated AIoT function, such as the AIoT function 506. The NEF 510 forwards the request message received from the AF 512 (e.g., at step 1) to the AIoT function 506. The forwarded request message (e.g., Nnef_EventExposure_Subscribe/Unsubscribe Request) includes the indication of the AIoT access network type.

At step 4, the AIoT function 506 confirms receipt of the forwarded request message by transmitting a response message (e.g., Naiotf_EventExposure_Subscribe/Unsubscribe Response) to the NEF 510.

At step 5, the AIoT device 502 connects (e.g., attaches) to the AIoT reader 504 as an access network. In some examples, the AIoT device 502 may be triggered by the AIoT reader 504 to initiate the connection, e.g., based on receiving a broadcast message from the AIoT reader 504. The connection may be an L2 connection.

At step 6, the AIoT reader 504 may transmit, to the AIoT device 502, an L2 message including an EAP-Identify Request. In some examples, step 6 may be included as part of step 5.

At step 7, the AIoT device 502 may transmit a response message to the AIoT reader 504. The response message may be, for example, an EAP-Identity Response message and may include an indication of a unique identifier of the AIoT device 502 (e.g., an NAI, such as a SUCI or 5G-GUTI) and/or an EPC of the AIoT device 502.

At step 8, the AIoT reader 504 may select an AIoT function of the network, such as the AIoT function 506. The AIoT reader 504 may select the AIoT function 506 based on a realm associated with the SUCI indicated by the AIoT device 502. The AIoT reader 504 may then generate a 5G core (5GC) registration request message for the AIoT device 502, and may transmit an N2 message to the AIoT function 506. The N2 message may include the registration request message, as well as information received from the AIoT device 402 (e.g., the EPC, a location of the AIoT device 402, or the like).

At step 9, the AIoT function 506 may select an AUSF of the network, such as the AUSF/UDM 508. The AIoT function 506 may transmit, to the AUSF/UDM 508, an authentication request message (e.g., Nausf_UEAuthentication_Authenticate Request). The authentication request message may include an indication of the SUCI (e.g., if the AIoT function 506 received the SUCI of the AIoT device 502 at step 9) or a SUPI (e.g., if the AIoT function 506 received the 5G-GUTI of the AIoT device 502 at step 9). Additionally, the authentication request message may include an indication that the authentication request is associated with (e.g., is for authentication of) an AIoT device (e.g., the AIoT device 502), which may be referred to as an AIoT device indication.

At step 10, the AUSF may transmit, to the UDM, a request message (e.g., Nudm_UEAuthentication_Get) that includes the SUCI or SUPI and the AIoT device indication. Upon reception of the request message, the UDM may initiate a SIDF if the request message includes the SUCI. The UDM may utilize the SIDF to de-conceal the SUCI to obtain the SUPI prior to processing the request message.

The UDM may select an authentication method based on a realm associated with the SUPI, the AIoT device indicator, a combination of the realm and the AIoT device indicator, or a UDM local policy. The UDM may generate an authentication vector AV according to the authentication method. The authentication vector AV may include a set of parameters, which may include, but is not limited to, a network challenge (e.g., RAND), an expected user response (e.g., XRES), a CK, an IK, and an AUTN. The UDM may transform the authentication vector AV into an authentication vector AV′ and may transmit the AV′ to the AUSF. In some cases, the UDM may also transmit an indication of an MSK to the AUSF to indicate that the AIoT device 502 does not support a 5G key hierarchy.

At step 11, the AUSF may transmit, to the AIoT function 506, an EAP-Request/AKA′-Challenge message, for instance, as part of a response message (e.g., a Nausf_UEAuthentication_Authenticate Response message).

At step 12, the AIoT function 506 may transparently forward the EAP-Request/AKA′-Challenge message to the AIoT reader 504, e.g., as part of an N2 message that includes an authentication request.

At step 13, the AIoT function 506 may forward the EAP-Request/AKA′-Challenge message to the AIoT device 502, e.g., as part of an L2 message.

At step 14, the AIoT device 502 may compute an authentication response message, e.g., based on receiving the EAP-Request/AKA′-Challenge message from the AIoT function 506. The computed authentication response message may include a user response (e.g., RES).

Referring now to FIG. 5b, at step 15, the AIoT device 502 may transmit the computed authentication response message (e.g., an EAP-Response/AKA′-Challenge message) to the AIoT reader 504, for instance, as part of an L2 Auth-Resp message.

At step 16, the AIoT reader 504 may transmit the authentication response message (e.g., the EAP-Response/AKA′-Challenge message received from the AIoT device 502) to the AIoT function 506, for example, as part of an N2 message that includes an authentication response.

At step 17, the AIoT function 506 may transparently forward the EAP-Response/AKA′-Challenge message to the AUSF, for example, as part of a Nausf_UEAuthentication_Authenticate request message.

At step 18, the AUSF may verify the authentication response message by comparing the XRES of the AV and the RES indicated in the authentication response message. If the verification is successful, for example, based on the MSK indicator received from the UDM at step 10, the AUSF may generate the MSK or may generate an authentication key K_{AUSF}. The AUSF may then calculate an access network security key for the AIoT device 502 (e.g., K_{AIOTF}) from the authentication key K_{AUSF}. In some examples, the AUSF may generate K_{AIOTF} in a manner similar to that used to generate other keys (e.g., K_{TNGF}/K_{TWIF}/K_{N3IWF}), but with an Uplink NAS Count set to “0”, or from the MSK. In some examples, the K_{AIOTF} may be the same as (e.g., equal to) the MSK.

At step 19, the AUSF may transmit, to the AIoT function 506, a Nausf_UEAuthentication_Authenticate Response message including an indication that the EAP was successful (e.g., EAP-Success), the K_{AIOTF}, the SUPI, and, if available, the GPSI.

At step 20, based on receiving the K_{AIOTF}, the SUPI, and, if available, the GPSI, the AIoT function 506 may transmit a success message (e.g., an EAP-Success message) to the AIoT reader 504. The success message may be included as part of an N2 initial context setup request message.

At step 21, the AIoT reader 504 may store the K_{AIOTF} and may forward the success message (e.g., the EAP-Success/EAP-5G message) to the AIoT device 502, e.g., as part of an L2 message.

At step 22, the AIoT device 502 may derive an access network security key K_{AIOTF}. In some examples, the AIoT device 502 may derive the K_{AIOTF} in a similar manner as the derivation performed by the AUSF, e.g., based on the SUPI, the GPSI, and/or the unique identifier associated with the AIoT device 502.

At step 23, the AIoT device 502 and the AIoT reader 504 may set up a secure L2 connection using the access network security key K_{AIOTF}, which may enable protection for any subsequent communications between the AIoT device 502 and the AIoT reader 504.

At step 24, the AIoT reader 504 may transmit, to the AIoT function 506, an N2 initial context setup response message.

At step 25, the AIoT function 506 may trigger a notification toward the AF 512. Based on the trigger, the AIoT function 506 may transmit, to the NEF 510, a Naiotf_Event Exposure_Notify message, which may include an indication of an event ID, an indication of an event filter, and any relevant event reporting information. Additionally, in some examples, the Naiotf_Event Exposure_Notify message may include the GPSI, the EPC, an indication of a location of the AIoT device 502, an indication of the AIoT access network type, or the like.

At step 26, the NEF 510 may forward the Naiotf_Event Exposure_Notify message to the AF 512. The Naiotf_Event Exposure_Notify message may contain the GPSI, the EPC, the indication of the location of the AIoT device 502, the indication of the AIoT access network type, or the like. of the device(s) authenticated with the AIoT function(s). In some examples, the NEF 510 may transmit a Naiotf_Event Exposure_Notify message that includes information associated with a single AIoT function 506, while in other examples, the NEF 510 may aggregate reporting information (e.g., event ID, event filter, event reporting information) for multiple AIoT functions and may include the aggregated reporting information in the Naiotf_Event Exposure_Notify message. In the latter case, the Naiotf_Event Exposure_Notify message may indicate a respective GPSI, EPC, location indication, and/or AIoT access network type indication for each of the AIoT devices authenticated by a respective AIoT function.

At step 27, the AF 512 may store information associated with the AIoT device 502, e.g., as indicated in the Naiotf_Event Exposure_Notify message received from the NEF 510.

At step 28, the AF 512 may transmit an acknowledgement of reception of the Naiotf_Event Exposure_Notify message to the NEF 510.

At step 29, the NEF 510 may transmit, to the AIoT function 506, an acknowledgement of reception of the Naiotf_Event Exposure_Notify message.

At step 30, the AIoT device 502 may retrieve (e.g., using a dynamic host configuration protocol (DCHP)) an IP configuration from the AIoT function 506.

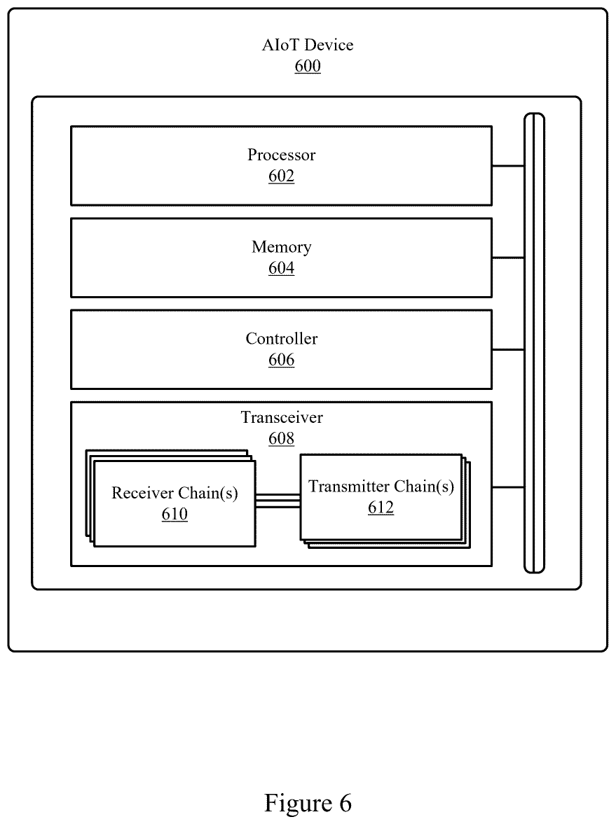

FIG. 6 illustrates an example of an AIoT device 600 in accordance with aspects of the present disclosure. The AIoT device 600 may include a processor 602, a memory 604, a controller 606, and a transceiver 608. The processor 602, the memory 604, the controller 606, or the transceiver 608, or various combinations thereof or various components thereof may be examples of means for performing various aspects of the present disclosure as described herein. These components may be coupled (e.g., operatively, communicatively, functionally, electronically, electrically) via one or more interfaces.

The processor 602, the memory 604, the controller 606, or the transceiver 608, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 602 may include an intelligent hardware device (e.g., a general-purpose processor, a DSP, a CPU, an ASIC, an FPGA, or any combination thereof). In some implementations, the processor 602 may be configured to operate the memory 604. In some other implementations, the memory 604 may be integrated into the processor 602. The processor 602 may be configured to execute computer-readable instructions stored in the memory 604 to cause the AIoT device 600 to perform various functions of the present disclosure.

The memory 604 may include volatile or non-volatile memory. The memory 604 may store computer-readable, computer-executable code including instructions when executed by the processor 602 cause the AIoT device 600 to perform various functions described herein. The code may be stored in a non-transitory computer-readable medium such as the memory 604 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 602 and the memory 604 coupled with the processor 602 may be configured to cause the AIoT device 600 to perform one or more of the functions described herein (e.g., executing, by the processor 602, instructions stored in the memory 604). For example, the processor 602 may support wireless communication at the AIoT device 600 in accordance with examples as disclosed herein. The AIoT device 600 may be configured to or operable to support a means for receiving, from a reader function, a first message comprising a broadcast message; performing an authentication procedure with a server function using, at least in part, the reader function and a network function, wherein the authentication procedure utilizes an EAP-AKA′ authentication method based at least in part on the device being associated with an AIoT access type; deriving, as a result of the authentication procedure, an access network security key; and establishing, using the access network security key, a secure connection with the reader function or the network function.

Additionally, the AIoT device 600 may be configured to support any one or combination of the device comprises an AIoT device that includes a USIM. The reader function comprises an AIoT reader; the network function comprises an AIoT function; and the server function comprises an AUSF. The first message comprises at least one of an identity request message broadcast by the reader function or an indication of an address of the network function. The method of performing the authentication procedure further comprises transmitting a second message indicating at least one of a unique AIoT identifier associated with the device or an electronic product code associated with the device. The second message comprises an IKE message or an EAP identity response message. The method further comprising receiving, from the network function and based at least in part on transmitting the second message, a third message indicating a successful result of the authentication procedure, and wherein the access network security key is derived using one or more of a SUPI, a GPSI, or the unique AIoT identifier associated with the device. The method further comprising receiving, from the reader function and based at least in part on transmitting the second message, a third message indicating at least one of a SUPI or a GPSI, wherein the access network security key is derived using one or more of the SUPI, the GPSI, or the unique AIoT identifier associated with the device. The secure connection comprises an IPSec SA between the device and the network function. The network function comprises a trusted WLAN interworking function; and the secure connection comprises a secure L2 connection between the device and the network function. The reader function comprises a trusted WLAN interworking function; and the secure connection comprises a secure L2 connection between the device and the reader function.

Additionally, or alternatively, the AIoT device 600 may support at least one memory (e.g., the memory 604) and at least one processor (e.g., the processor 602) coupled with the at least one memory and configured to cause the AIoT device to: receive, from a reader function, a first message comprising a broadcast message; perform an authentication procedure with a server function using, at least in part, the reader function and a network function, wherein the EAP-AKA′ authentication method based at least in part on the device being associated with an AIoT access type; derive, as a result of the authentication procedure, an access network security key; and establish, using the access network security key, a secure connection with the reader function or the network function.

Additionally, the AIoT device 600 may be configured to support any one or combination of the device comprises an AIoT device that includes a USIM. The reader function comprises an AIoT reader; the network function comprises an AIoT function; and the server function comprises an AUSF. The first message comprises at least one of an identity request message broadcast by the reader function or an indication of an address of the network function. To perform the authentication procedure, the at least one processor is configured to cause the device to transmit a second message indicating at least one of a unique AIoT identifier associated with the device or an electronic product code associated with the device. The second message comprises an IKE message or an EAP identity response message. The at least one processor is configured to cause the device to receive, from the network function and based at least in part on transmitting the second message, a third message indicating a successful result of the authentication procedure, and wherein the access network security key is derived using one or more of a SUPI, a GPSI, or the unique AIoT identifier associated with the device. The at least one processor is configured to cause the device to receive, from the reader function and based at least in part on transmitting the second message, a third message indicating at least one of a SUPI or a GPSI, and wherein the access network security key is derived using one or more of the SUPI, the GPSI, or the unique AIoT identifier associated with the device. The secure connection comprises an IPSec SA between the device and the network function. The network function comprises a trusted WLAN interworking function; and the secure connection comprises a secure L2 connection between the device and the network function. The reader function comprises a trusted WLAN interworking function; and the secure connection comprises a secure L2 connection between the device and the reader function.

The controller 606 may manage input and output signals for the AIoT device 600. The controller 606 may also manage peripherals not integrated into the AIoT device 600. In some implementations, the controller 606 may utilize an operating system such as iOS®, ANDROID®, WINDOWS®, or other operating systems. In some implementations, the controller 606 may be implemented as part of the processor 602.

In some implementations, the AIoT device 600 may include at least one transceiver 608. In some other implementations, the AIoT device 600 may have more than one transceiver 608. The transceiver 608 may represent a wireless transceiver. The transceiver 608 may include one or more receiver chains 610, one or more transmitter chains 612, or a combination thereof.

A receiver chain 610 may be configured to receive signals (e.g., control information, data, packets) over a wireless medium. For example, the receiver chain 610 may include one or more antennas to receive a signal over the air or wireless medium. The receiver chain 610 may include at least one amplifier (e.g., a low-noise amplifier (LNA)) configured to amplify the received signal. The receiver chain 610 may include at least one demodulator configured to demodulate the receive signal and obtain the transmitted data by reversing the modulation technique applied during transmission of the signal. The receiver chain 610 may include at least one decoder for decoding the demodulated signal to receive the transmitted data.

A transmitter chain 612 may be configured to generate and transmit signals (e.g., control information, data, packets). The transmitter chain 612 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 612 may also include at least one power amplifier configured to amplify the modulated signal to an appropriate power level suitable for transmission over the wireless medium. The transmitter chain 612 may also include one or more antennas for transmitting the amplified signal into the air or wireless medium.

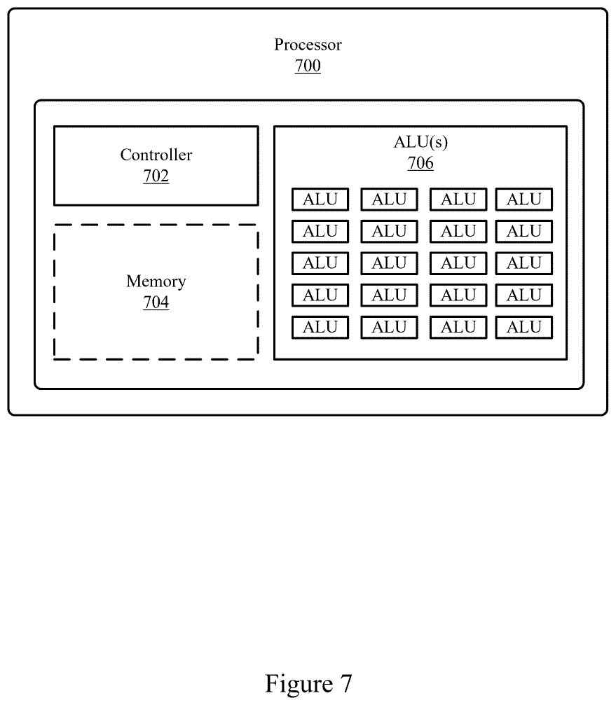

FIG. 7 illustrates an example of a processor 700 in accordance with aspects of the present disclosure. The processor 700 may be an example of a processor configured to perform various operations in accordance with examples as described herein. The processor 700 may include a controller 702 configured to perform various operations in accordance with examples as described herein. The processor 700 may optionally include at least one memory 704, which may be, for example, an L1/L2/L3 cache. Additionally, or alternatively, the processor 700 may optionally include one or more arithmetic-logic units (ALUs) 706. One or more of these components may be in electronic communication or otherwise coupled (e.g., operatively, communicatively, functionally, electronically, electrically) via one or more interfaces (e.g., buses).

The processor 700 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 700) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 702 may be configured to manage and coordinate various operations (e.g., signaling, receiving, obtaining, retrieving, transmitting, outputting, forwarding, storing, determining, identifying, accessing, writing, reading) of the processor 700 to cause the processor 700 to support various operations in accordance with examples as described herein. For example, the controller 702 may operate as a control unit of the processor 700, generating control signals that manage the operation of various components of the processor 700. These control signals include enabling or disabling functional units, selecting data paths, initiating memory access, and coordinating timing of operations.

The controller 702 may be configured to fetch (e.g., obtain, retrieve, receive) instructions from the memory 704 and determine subsequent instruction(s) to be executed to cause the processor 700 to support various operations in accordance with examples as described herein. The controller 702 may be configured to track memory addresses of instructions associated with the memory 704. The controller 702 may be configured to decode instructions to determine the operation to be performed and the operands involved. For example, the controller 702 may be configured to interpret the instruction and determine control signals to be output to other components of the processor 700 to cause the processor 700 to support various operations in accordance with examples as described herein. Additionally, or alternatively, the controller 702 may be configured to manage flow of data within the processor 700. The controller 702 may be configured to control transfer of data between registers, ALUs 706, and other functional units of the processor 700.

The memory 704 may include one or more caches (e.g., memory local to or included in the processor 700 or other memory, such as RAM, ROM, DRAM, SDRAM, SRAM, MRAM, flash memory, etc. In some implementations, the memory 704 may reside within or on a processor chipset (e.g., local to the processor 700). In some other implementations, the memory 704 may reside external to the processor chipset (e.g., remote to the processor 700).

The memory 704 may store computer-readable, computer-executable code including instructions that, when executed by the processor 700, cause the processor 700 to perform various functions described herein. The code may be stored in a non-transitory computer-readable medium such as system memory or another type of memory. The controller 702 and/or the processor 700 may be configured to execute computer-readable instructions stored in the memory 704 to cause the processor 700 to perform various functions. For example, the processor 700 and/or the controller 702 may be coupled with or to the memory 704, the processor 700, and the controller 702, and may be configured to perform various functions described herein. In some examples, the processor 700 may include multiple processors and the memory 704 may include multiple memories. One or more of the multiple processors may be coupled with one or more of the multiple memories, which may, individually or collectively, be configured to perform various functions herein.

The one or more ALUs 706 may be configured to support various operations in accordance with examples as described herein. In some implementations, the one or more ALUs 706 may reside within or on a processor chipset (e.g., the processor 700). In some other implementations, the one or more ALUs 706 may reside external to the processor chipset (e.g., the processor 700). One or more ALUs 706 may perform one or more computations such as addition, subtraction, multiplication, and division on data. For example, one or more ALUs 706 may receive input operands and an operation code, which determines an operation to be executed. One or more ALUs 706 may be configured with a variety of logical and arithmetic circuits, including adders, subtractors, shifters, and logic gates, to process and manipulate the data according to the operation. Additionally, or alternatively, the one or more ALUs 706 may support logical operations such as AND, OR, exclusive-OR (XOR), not-OR (NOR), and not-AND (NAND), enabling the one or more ALUs 706 to handle conditional operations, comparisons, and bitwise operations.

The processor 700 may support wireless communication in accordance with examples as disclosed herein. The processor 700 may be configured to or operable to support at least one controller (e.g., the controller 702) coupled with at least one memory (e.g., the memory 704) and configured to cause the processor to: receive, from a reader function, a first message comprising a broadcast message; perform an authentication procedure with a server function using, at least in part, the reader function and a network function, wherein the authentication procedure utilizes an EAP-AKA′ authentication method based at least in part on an association with an AIoT access type; derive, as a result of the authentication procedure, an access network security key; and establish, using the access network security key, a secure connection with the reader function or the network function.

Additionally, the processor 700 may be configured to or operable to support any one or combination of the processor is associated with an AIoT device that includes a USIM. The reader function comprises an AIoT reader; the network function comprises an AIoT function; and the server function comprises an AUSF. The first message comprises at least one of an identity request message broadcast by the reader function or an indication of an address of the network function. To perform the authentication procedure, the controller is configured to cause the processor to transmit a second message indicating at least one of a unique AIoT identifier associated with a device or an electronic product code associated with the device. The second message comprises an IKE message or an EAP identity response message. The controller is configured to cause the processor to receive, from the network function and based at least in part on transmitting the second message, a third message indicating a successful result of the authentication procedure, and wherein the access network security key is derived using one or more of a SUPI, a GPSI, or the unique AIoT identifier associated with the device. The controller is configured to cause the processor to receive, from the reader function and based at least in part on transmitting the second message, a third message indicating at least one of a SUPI or a GPSI, and wherein the access network security key is derived using one or more of the SUPI, the GPSI, or the unique AIoT identifier associated with the device. The secure connection comprises an IPSec SA between the device and the network function. The network function comprises a trusted WLAN interworking function; and the secure connection comprises a secure L2 connection between a device and the network function. The reader function comprises a trusted WLAN interworking function; and the secure connection comprises a secure L2 connection between a device and the reader function.

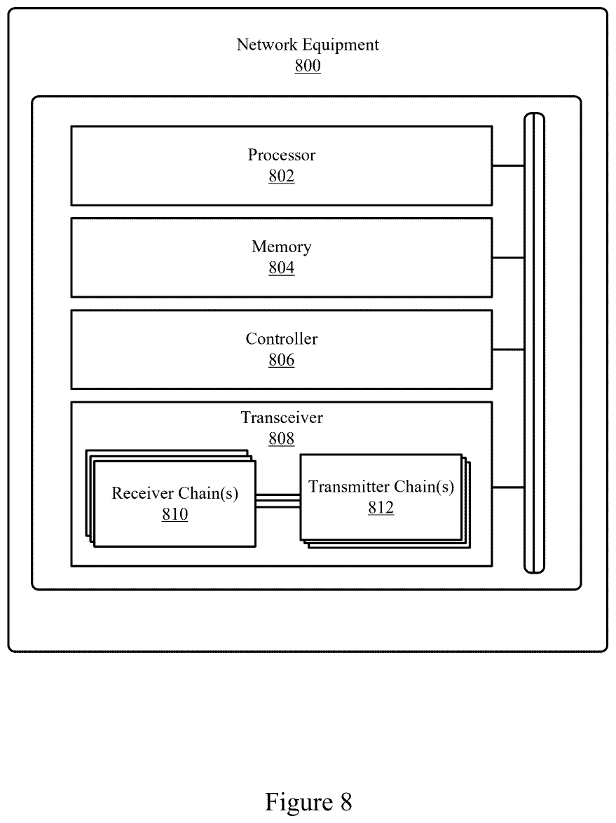

FIG. 8 illustrates an example of a NE 800 in accordance with aspects of the present disclosure. The NE 800 (e.g., an AF) may include a processor 802, a memory 804, a controller 806, and a transceiver 808. The processor 802, the memory 804, the controller 806, or the transceiver 808, or various combinations thereof or various components thereof may be examples of means for performing various aspects of the present disclosure as described herein. These components may be coupled (e.g., operatively, communicatively, functionally, electronically, electrically) via one or more interfaces.

The processor 802, the memory 804, the controller 806, or the transceiver 808, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 802 may include an intelligent hardware device (e.g., a general-purpose processor, a DSP, a CPU, an ASIC, an FPGA, or any combination thereof). In some implementations, the processor 802 may be configured to operate the memory 804. In some other implementations, the memory 804 may be integrated into the processor 802. The processor 802 may be configured to execute computer-readable instructions stored in the memory 804 to cause the NE 800 to perform various functions of the present disclosure.

The memory 804 may include volatile or non-volatile memory. The memory 804 may store computer-readable, computer-executable code including instructions when executed by the processor 802 cause the NE 800 to perform various functions described herein. The code may be stored in a non-transitory computer-readable medium such as the memory 804 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 802 and the memory 804 coupled with the processor 802 may be configured to cause the NE 800 to perform one or more of the functions described herein (e.g., executing, by the processor 802, instructions stored in the memory 804). For example, the processor 802 may support wireless communication at the NE 800 in accordance with examples as disclosed herein. The NE 800 may be configured to or operable to support a means for transmitting, to a NEF, a first message indicating an AIoT access network type; receiving, from the NEF and based at least in part on an authentication procedure for an AIoT device associated with the AIoT access network type, a second message indicating one or more parameters associated with the AIoT device; and performing communications with the AIoT device based at least in part on the one or more parameters.

Additionally, the NE 800 may be configured to or operable to support any one or combination of the method further comprising the first message includes a subscribe request for authenticated AIoT devices including the AIoT device. The one or more parameters comprise at least one of a GPSI associated with the AIoT device, an electronic product code associated with the AIoT device, or a location of the AIoT device.

Additionally, or alternatively, the NE 800 may support at least one memory (e.g., the memory 804) and at least one processor (e.g., the processor 802) coupled with the at least one memory and configured to cause the NE to: transmit, to a NEF, a first message indicating an AIoT access network type; receive, from the NEF and based at least in part on an authentication procedure for an AIoT device associated with the AIoT access network type, a second message indicating one or more parameters associated with the AIoT device; and perform communications with the AIoT device based at least in part on the one or more parameters.

Additionally, the NE 800 may be configured to support any one or combination of the first message includes a subscribe request for authenticated AIoT devices including the AIoT device. The one or more parameters comprise at least one of a GPSI associated with the AIoT device, an electronic product code associated with the AIoT device, or a location of the AIoT device.

The controller 806 may manage input and output signals for the NE 800. The controller 806 may also manage peripherals not integrated into the NE 800. In some implementations, the controller 806 may utilize an operating system such as iOS®, ANDROID®, WINDOWS®, or other operating systems. In some implementations, the controller 806 may be implemented as part of the processor 802.

In some implementations, the NE 800 may include at least one transceiver 808. In some other implementations, the NE 800 may have more than one transceiver 808. The transceiver 808 may represent a wireless transceiver. The transceiver 808 may include one or more receiver chains 810, one or more transmitter chains 812, or a combination thereof.

A receiver chain 810 may be configured to receive signals (e.g., control information, data, packets) over a wireless medium. For example, the receiver chain 810 may include one or more antennas to receive a signal over the air or wireless medium. The receiver chain 810 may include at least one amplifier (e.g., a low-noise amplifier (LNA)) configured to amplify the received signal. The receiver chain 810 may include at least one demodulator configured to demodulate the receive signal and obtain the transmitted data by reversing the modulation technique applied during transmission of the signal. The receiver chain 810 may include at least one decoder for decoding the demodulated signal to receive the transmitted data.

A transmitter chain 812 may be configured to generate and transmit signals (e.g., control information, data, packets). The transmitter chain 812 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 812 may also include at least one power amplifier configured to amplify the modulated signal to an appropriate power level suitable for transmission over the wireless medium. The transmitter chain 812 may also include one or more antennas for transmitting the amplified signal into the air or wireless medium.

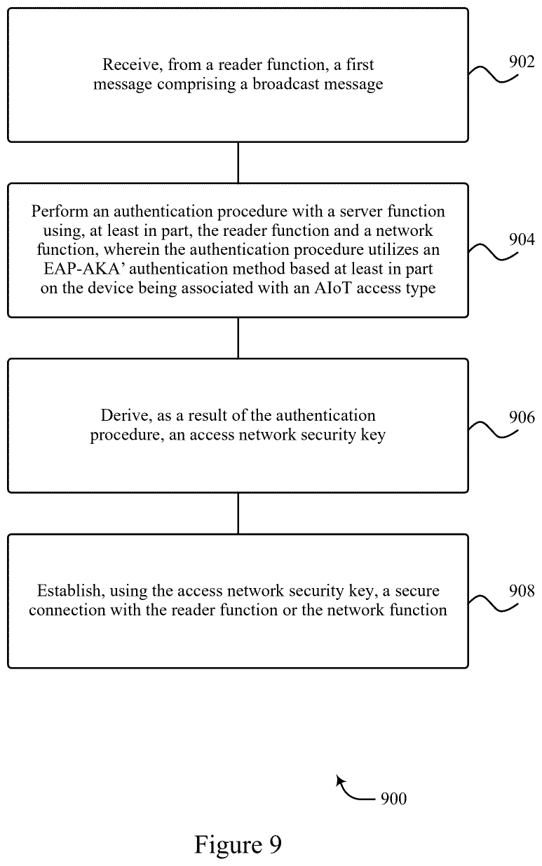

FIG. 9 illustrates a flowchart of a method 900 in accordance with aspects of the present disclosure. The operations of the method may be implemented by a AIoT device as described herein. In some implementations, the AIoT device may execute a set of instructions to control the function elements of the AIoT device to perform the described functions. It should be noted that the method described herein describes a possible implementation, and that the operations and the steps may be rearranged or otherwise modified and that other implementations are possible.

At 902, the method may include receiving, from a reader function, a first message comprising a broadcast message. The operations of 902 may be performed in accordance with examples as described herein. In some implementations, aspects of the operations of 902 may be performed by a AIoT device as described with reference to FIG. 6.

At 904, the method may include performing an authentication procedure with a server function using, at least in part, the reader function and a network function, wherein the authentication procedure utilizes an EAP-AKA′ authentication method based at least in part on the device being associated with an AIoT access type. The operations of 904 may be performed in accordance with examples as described herein. In some implementations, aspects of the operations of 904 may be performed by a AIoT device as described with reference to FIG. 6.

At 906, the method may include deriving, as a result of the authentication procedure, an access network security key. The operations of 906 may be performed in accordance with examples as described herein. In some implementations, aspects of the operations of 906 may be performed a AIoT device as described with reference to FIG. 6.

At 908, the method may include establishing, using the access network security key, a secure connection with the reader function or the network function. The operations of 908 may be performed in accordance with examples as described herein. In some implementations, aspects of the operations of 908 may be performed a AIoT device as described with reference to FIG. 6.

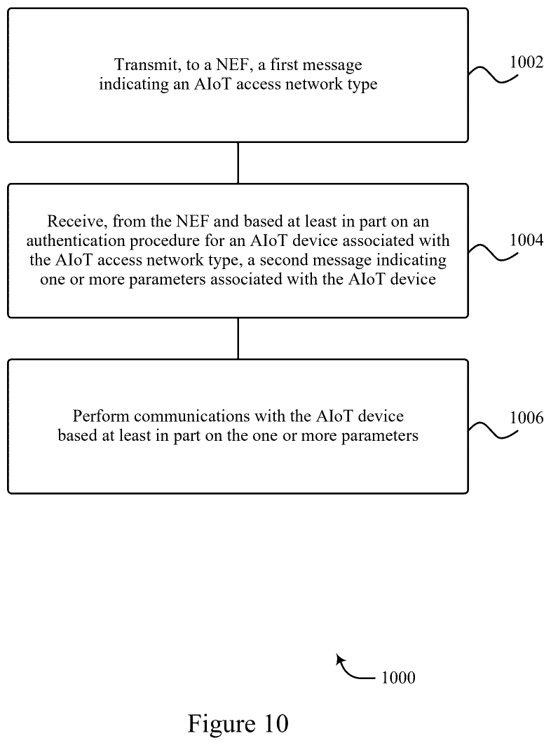

FIG. 10 illustrates a flowchart of a method 1000 in accordance with aspects of the present disclosure. The operations of the method may be implemented by a NE (e.g., an AF) as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1002, the method may include transmitting, to a NEF, a first message indicating an AIoT access network type. The operations of 1002 may be performed in accordance with examples as described herein. In some implementations, aspects of the operations of 1002 may be performed by a NE as described with reference to FIG. 8.

At 1004, the method may include receiving, from the NEF and based at least in part on an authentication procedure for an AIoT device associated with the AIoT access network type, a second message indicating one or more parameters associated with the AIoT device. The operations of 1004 may be performed in accordance with examples as described herein. In some implementations, aspects of the operations of 1004 may be performed by a NE as described with reference to FIG. 8.

At 1006, the method may include performing communications with the AIoT device based at least in part on the one or more parameters. The operations of 1006 may be performed in accordance with examples as described herein. In some implementations, aspects of the operations of 1006 may be performed a NE as described with reference to FIG. 8.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A device for wireless communication, comprising:
at least one memory; and
at least one processor coupled with the at least one memory and configured to cause the device to:
receive, from a reader function, a first message comprising a broadcast message;
perform an authentication procedure with a server function using, at least in part, the reader function and a network function, wherein the authentication procedure utilizes an extensible authentication protocol (EAP) authentication and key agreement prime (EAP-AKA′) authentication method based at least in part on the device being associated with an ambient internet of things (AIoT) access type;
derive, as a result of the authentication procedure, an access network security key; and
establish, using the access network security key, a secure connection with the reader function or the network function.

2. The device of claim 1, wherein the device comprises an AIoT device that includes a universal subscriber identity module (USIM).

3. The device of claim 1, wherein:
the reader function comprises an AIoT reader;
the network function comprises an AIoT function; and
the server function comprises an authentication server function (AUSF).

4. The device of claim 1, wherein the first message comprises at least one of an identity request message broadcast by the reader function or an indication of an address of the network function.

5. The device of claim 1, wherein to perform the authentication procedure, the at least one processor is configured to cause the device to transmit a second message indicating at least one of a unique AIoT identifier associated with the device or an electronic product code associated with the device.

6. The device of claim 5, wherein the second message comprises an Internet key exchange (IKE) message or an EAP identity response message.

7. The device of claim 5, wherein the at least one processor is configured to cause the device to receive, from the network function and based at least in part on transmitting the second message, a third message indicating a successful result of the authentication procedure, and wherein the access network security key is derived using one or more of a subscription permanent identifier (SUPI), a global phone subscription identifier (GPSI), or the unique AIoT identifier associated with the device.

8. The device of claim 5, wherein the at least one processor is configured to cause the device to receive, from the reader function and based at least in part on transmitting the second message, a third message indicating at least one of a subscription permanent identifier (SUPI) or a global phone subscription identifier (GPSI), and wherein the access network security key is derived using one or more of the SUPI, the GPSI, or the unique AIoT identifier associated with the device.

9. The device of claim 1, wherein the secure connection comprises an internet protocol security (IPSec) security association (IPSec SA) between the device and the network function.

10. The device of claim 1, wherein:
the network function comprises a trusted wireless local-area network (WLAN) interworking function; and
the secure connection comprises a secure Layer 2 (L2) connection between the device and the network function.

11. The device of claim 1, wherein:
the reader function comprises a trusted wireless local-area network (WLAN) interworking function; and
the secure connection comprises a secure Layer 2 (L2) connection between the device and the reader function.

12. A processor for wireless communication, comprising:
at least one controller coupled with at least one memory and configured to cause the processor to:
receive, from a reader function, a first message comprising a broadcast message;
perform an authentication procedure with a server function using, at least in part, the reader function and a network function, wherein the authentication procedure utilizes an extensible authentication protocol (EAP) authentication and key agreement prime (EAP-AKA′) authentication method based at least in part on an association with an ambient internet of things (AIoT) access type;
derive, as a result of the authentication procedure, an access network security key; and
establish, using the access network security key, a secure connection with the reader function or the network function.

13. A method performed by a device, the method comprising:
receiving, from a reader function, a first message comprising a broadcast message;
performing an authentication procedure with a server function using, at least in part, the reader function and a network function, wherein the authentication procedure utilizes an extensible authentication protocol (EAP) authentication and key agreement prime (EAP-AKA′) authentication method based at least in part on the device being associated with an ambient internet of things (AIoT) access type;
deriving, as a result of the authentication procedure, an access network security key; and
establishing, using the access network security key, a secure connection with the reader function or the network function.

14. The method of claim 13, wherein the device comprises an AIoT device that includes a universal subscriber identity module (USIM).

15. The method of claim 13, wherein:
the reader function comprises an AIoT reader;
the network function comprises an AIoT function; and
the server function comprises an authentication server function (AUSF).

16. The method of claim 13, wherein the first message comprises at least one of an identity request message broadcast by the reader function or an indication of an address of the network function.

17. The method of claim 13, wherein performing the authentication procedure further comprises:
transmitting a second message indicating at least one of a unique AIoT identifier associated with the device or an electronic product code associated with the device.

18. A device for wireless communication, comprising:
at least one memory; and
at least one processor coupled with the at least one memory and configured to cause the device to:
transmit, to a network exposure function (NEF), a first message indicating an ambient internet of things (AIoT) access network type;
receive, from the NEF and based at least in part on an authentication procedure for an AIoT device associated with the AIoT access network type, a second message indicating one or more parameters associated with the AIoT device; and
perform communications with the AIoT device based at least in part on the one or more parameters.

19. The device of claim 18, wherein the first message includes a subscribe request for authenticated AIoT devices including the AIoT device.

20. The device of claim 18, wherein the one or more parameters comprise at least one of a global phone subscription identifier (GPSI) associated with the AIoT device, an electronic product code associated with the AIoT device, or a location of the AIoT device.
